(19) United States
(12) Patent Application Publication
(10) Pub. No.: US 2004/0000446 A1
(43) Pub. Date: Jan. 1, 2004

(54) Seismic signaling apparatus and method for enhancing signal repeatability

(76) Inventor: Harold P. Barber SR., Fulshear, TX (US)

Correspondence Address: Lawrence R. Youst, Danamraj & Youst, P.C, Suite 1200, LB-15, 12900 Preston Road, Dallas, TX, 75230-1328, US

(21) Appl. No.: 10/609,035

(22) Filed: Jun. 27, 2003

Related U.S. Application Data
(60) Provisional application No. 60/392,917, filed on Jul. 1, 2002.

(51) Int. Cl. G01V 1/06

(52) U.S. Cl. 181/120; 181/116; 367/144

(57) ABSTRACT

A seismic signaling apparatus (100) and method for enhancing the repeatability of the generated seismic signals are disclosed. The seismic signaling apparatus (100) includes a support frame (102) having an air-gun array (114) operably mounted thereto. The air-gun array (114) includes a plurality of air-guns (118, 120, 122) that are positioned such that a tapered, heavy centered, point source seismic signal is generated upon firing of the air-gun array (114). Shock absorbing members (124) are attached to adjacent air-guns (118, 120, 122) in order to absorb the force generated by the firing of the air-gun array (114). In particular, the shock absorbing members (124) absorb the forces associated with air-gun recoil to minimize the movement of the air-guns (118, 120, 122) relative to each other and the support frame (102), thereby stabilizing the air-gun array (114) and enhancing the repeatability of the generated seismic signals.

### PRIORITY UNDER 35 U.S.C. §119(3) AND 37 C.F.R. §1.78

The present nonprovisional patent application claims priority based upon pending U.S. Provisional patent application serial No. 60/392,917 which was filed Jul. 1, 2002.

### TECHNICAL FIELD OF THE INVENTION

The present invention relates, in general, to marine seismic exploration and, more particularly, to a seismic signaling apparatus that generates a tapered, heavy centered, point source seismic signal and a method for enhancing the signal repeatability of the seismic signaling apparatus.

### BACKGROUND OF THE INVENTION

Marine seismic exploration of the earth strata located below a body of water, usually offshore, is well known. One common use is in the prospecting for hydrocarbons or other natural resources contained or trapped in relative deep formations in the earth crust. Another common use is obtaining engineering survey data and shallow strata information useful and necessary for suitable siting and foundation design of offshore structures, such as jack up rigs or permanent platforms for drilling and production operations.

In principal and theory, seismic prospecting is relatively simple. A pulse of seismic energy is produced from a known source and transmitted through the earth strata. The reflected energy signals from the subsurface strata and strata interfaces are detected and recorded as data by suitable instrumentation. The data is then processed using source signal deconvolution or other suitable technique such that a model of the subsurface strata may be constructed including, for example, the depth, arrangement and thickness of the various layers or formations forming the strata.

In actual practice of seismic prospecting, the detection and processing calculations of the reflected energy signal data to predict the details of the investigated strata or formations is extremely complex and quite difficult. Each seismic energy source produces an energy signal having unique characteristics known as the source signature. In deconvolution, the signature characteristics are used to adjust the recorded data for those known imperfections in the seismic signal. Separating a true reflected seismic signal in the recorded data from noise or other signal echoes is an extremely difficult task and requires a great deal of skill and expertise. Furthermore, the characteristics of the pulse actually generated by the seismic source for transmission through the earth strata can greatly increase the difficulty of sensing or detecting the proper strata reflected energy or pulse signal. False detection of the reflected information will, of course, render the seismic determinations on that information incorrect.

One approach that has been made to improve the desired characteristics of the source signal, which is illustrative of the existing solutions, is the apparatus for seismic exploration disclosed in U.S. Pat. No. 4,956,822, issued in the names of Barber et al, (hereinafter “Barber”). In Barber, a towable marine seismic source apparatus includes a support frame onto which a plurality of air-guns are positioned in a horizontal orientation in order to simultaneously provide a tapered, heavy centered point source. Cross members and cross braces secure the plurality of air-guns to the support frame. Upon a simultaneous or sequenced firing of the plurality of air-guns, the air-guns recoil and move vertically and horizontally relative to the frame and each other due to the force of the firing. The vertical and horizontal movements resulting from the recoil negatively impact the stability of the seismic source apparatus, thereby adversely affecting the precision and the accuracy of subsequent firings of the apparatus. In some cases, the vertical and horizontal movements the air-guns experience may be violent, resulting in damage to the seismic source apparatus.

Accordingly, a need exists for a seismic signaling apparatus which overcomes the limitations of the existing apparatuses for seismic exploration while providing a tapered, heavy centered, point source seismic signal. Moreover, a need exists for a seismic signaling apparatus which provides an enhanced degree of repeatability in order to provide accurate and precise performance. Further, a need exists for a seismic signaling apparatus which provides stability to the air-guns.

### SUMMARY OF THE INVENTION

The present invention disclosed herein provides a seismic signaling apparatus which overcomes the limitations of the existing solutions by providing a tapered, heavy centered, point source seismic signal. Moreover, the seismic signaling apparatus of the present invention maintains air-gun stability during firing which enhances the repeatability of the seismic signal. Further, the stability of the seismic signaling apparatus of the present invention prevents damage to the components caused by the recoil of firing. The seismic signaling apparatus achieves these results by employing shock absorbing members between the air-guns in order to absorb the recoil of the air-guns during and following the firing of the air-guns.

The seismic signaling apparatus of the present invention comprises a support frame and an air-gun array that is operably mounted to the support frame such that a tapered, heavy centered, point source seismic signal is generated upon firing the air-gun array. At least one shock absorbing member is attached to a pair of adjacent air-guns in the air-gun array. The shock absorbing member is operable to absorb a force generated upon firing the air-gun array.

In one embodiment, the air-gun array has air-guns in two parallel vertical planes. In this embodiment, shock absorbing members are attached to respective pairs of adjacent air-guns in the two parallel vertical planes to minimize the horizontal movement of the air-guns. In another embodiment, the air-gun array has air-guns in two parallel horizontal planes. In this embodiment, shock absorbing members are attached to respective pairs of adjacent air-guns in the two parallel horizontal planes to minimize the vertical movement of the air-guns. In yet another embodiment, the air-gun array has air-guns in two parallel vertical planes and air-guns in two parallel horizontal planes. In this embodiment, shock absorbing members are attached to respective pairs of adjacent air-guns in the two parallel vertical planes and respective pairs of adjacent air-guns in the two parallel horizontal planes to minimize both the horizontal and vertical movement of the air-guns.

The seismic signaling apparatus of the present invention may be configured for static deployment in the water. Alternatively, the seismic signaling apparatus of the present invention may be configured for towing in the water behind a marine vessel. In either case, the seismic signaling apparatus of the present invention may utilize a global positioning system receiver that is operable to communicate with a global positioning system in order to determine the location of the seismic signaling apparatus.

In another aspect, the present invention comprises a method for enhancing the signal repeatability of a seismic signaling apparatus that includes the steps of deploying the seismic signaling apparatus in the water, the seismic signaling apparatus including an air-gun array operably mounted to the support frame, firing the air-guns in the air-gun array to producing a tapered, heavy centered, point source seismic signal and absorbing a force between at least two of the air-guns in the air-gun array generated upon firing the air-gun array with a shock absorbing member attached to the at least two of the air-guns.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 depicts a schematic diagram of a system for seismic signaling wherein a marine vessel is towing a seismic signaling apparatus of the present invention;

FIG. 2 depicts a schematic diagram of a static deployment of the seismic signaling apparatus of the present invention;

FIG. 3 depicts a schematic diagram of an oilfield wherein the seismic signaling apparatus of the present invention is employed;

FIG. 4 depicts a side view of the seismic signaling apparatus of the present invention;

FIG. 5 depicts a cross-sectional view of the seismic signaling apparatus of the present invention as viewed along line 5-5 of FIG. 4;

FIG. 6 depicts a cross-sectional view of the seismic signaling apparatus of the present invention as viewed along line 6-6 of FIG. 4;

FIG. 7 depicts a cross-sectional view of the seismic signaling apparatus of the present invention as viewed along line 7-7 of FIG. 4; and

FIG. 8 depicts a front plan view of a spring-loaded shock mount that is positionable between two adjacent air-guns of the seismic signaling apparatus of the present invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

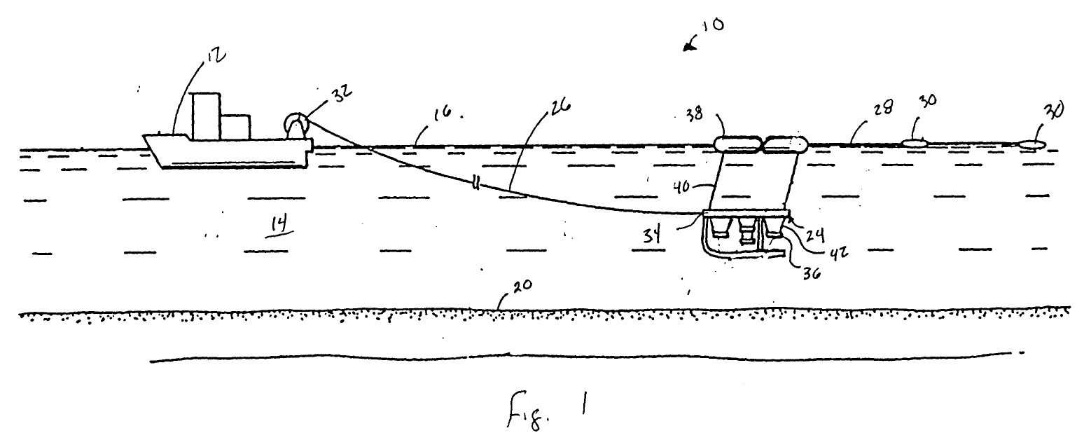

Referring initially to FIG. 1, a system for seismic signaling 10 is illustrated wherein a self-propelled marine seismic vessel 12 is shown traversing a body of water 14. An air-water interface is defined by the water surface 16 and the water-earth interface is defined by the mudline 20. Although a typical offshore marine environment found in bays, oceans, gulfs and the like is shown, it will be understood that the present invention may be used in any other marine environments such as a river, swamp, marsh and the like. Vessel 12 tows a seismic signal source 24 on a towing cable 26. A streamer cable 28 with receivers 30 such as hydrophones, which respond to acoustic wave reflections from the subsurface formations and produce output signals which are transmitted to the vessel 12, can be towed behind the seismic signal source 24.

Preferably, seismic signal source 24 is towed at a closer distance to the vessel 12 than receivers 30. Towing cable 26 extends between a reel 32 on vessel 12 and seismic signal source 24. In addition, a control cable umbilical (not pictured) extends between vessel 12 and seismic signal source 24 that includes high-pressure air supply conduits, timing lines and firing lines for operating seismic signal source 24.

Seismic signal source 24 includes a skid mounted support frame 34, an array of air-guns 36 and floatation devices 38. Support frame 34 is suspended in water 14 from floatation devices 38 by lines 40 that preferably locate the centerline of air-guns 36 at a depth of one to four meters below surface 16. Air-guns 36 are suspended from support frame 34 by gun hangers 42. Air-guns 36 are preferably arranged as a three-dimensional, heavy centered, tapered array that acts as a symmetrical marine seismic point source suitable for use in all water depths and for many survey applications including conventional seismic acquisition (2D and 3D), high-resolution engineering seismic, vertical seismic profiling, reservoir monitoring applications (4D) and the like. All of the air-guns 36 in the array may be fired simultaneously or may be sequentially timed. As discussed in greater detail below, air-guns 36 have a shock-mounted suspension that improves the repeatability of the seismic signal generated by seismic signal source 24. In particular, spring-loaded shock mounts positioned between the air-guns absorb recoil and provide improved stability to the seismic signal source 24 that translates into, repeatable, accurate and precise performance.

Each of air-guns 36 in the array are preferably of the same construction having the same air volume. It should be noted by those skilled in the art, however, that seismic signal source 24 is scalable which allows air-guns having different constructions or different air volumes to be suspended from support frame 34. Likewise, air-guns having different constructions or different air volumes may even be used within a single array of air-guns without departing from the principles of the present invention.

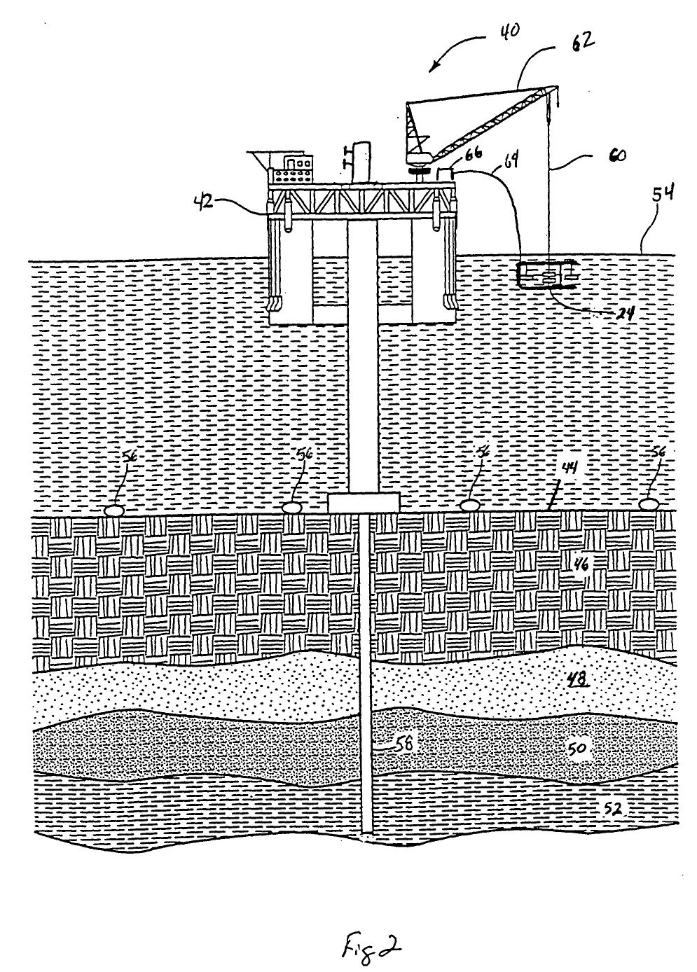

Referring next to FIG. 2 a non-towed or static deployment of seismic signal source 24 of the present invention is schematically illustrated and generally designated 40. A semi-submersible platform 42 is positioned in a body of water disposed above sea floor 44. Below sea floor 44 is located a plurality of the subsurface formations 46, 48, 50 and 52 to be investigated by seismic exploration techniques using the method and apparatus of the present invention. Mounted on platform 42 is support equipment for handling and operating seismic signal source 24. Such suitable support equipment and its use and operation are well known to those of skill in the art.

In the illustrated embodiment, during seismic exploration operations using seismic signal source 24, platform 42 will be used to repeatedly position seismic signal source 24 beneath the surface 54 of the water. Platform 42 may also serve to support a suitable array of seismic signal receivers 56, such as hydrophones that receive the returned seismic signal from the subsurface formations. Such signals are transmitted from receivers 56 to platform 42 in a conventional manner for recording and processing of the signals for monitoring or observation of changes in, for example, formations 48, 50 and 52 which may represent, respectively, a gas cap, an oil reservoir and a water layer.

Alternatively, and as illustrated, seismic signal receivers 56 may be permanently disposed on sea floor 44 or may be placed beneath sea floor 44 within formation 46. As another alternative, seismic signal receivers 56 may be temporarily disposed downhole within wellbore 58 during a vertical seismic profiling operation. In any of the above described configurations, however, it is desirable that seismic signal receivers 56 are placed in the same location or permanently remain in the same location for each use of seismic signal source 24 throughout the life of platform 42.

During the use of seismic signal source 24 of the present invention, a support line 60 extends between seismic signal source 24 and a conventional support structure such as a crane 62 that may be used to deploy and retrieve seismic signal source 24. In addition, a control cable umbilical 64 extends between seismic signal source 24 and a conventional operating mechanism 66 which may include an air compressor and electrical control equipment that provide a high pressure air supply and operations control to seismic signal source 24.

It is contemplated that the seismic signal source 24 of the present invention will be operated on a periodic basis, such as monthly or yearly to monitor changes in the fluid levels within formations 48, 50 and 52. Specifically, seismic signal source 24 and seismic signal receivers 56 may be used to provide information relating to the location of the gas cap as well as the interface between the oil and the water as fluid production proceeds into wellbore 58. For example, if it is desired to produce oil from formation 50, the pressure within formation 50 will decrease over time. This decrease in pressure will cause the gas cap to expand thereby lowering the interface between the gas and the oil. Similarly, as the volume of oil within formation 50 is reduced due to production, the water will continue to migrate upward thereby causing the level of the interface between the oil and the water to rise. With the periodic use of the static non-towed marine seismic system of the present invention, this type of formation information may be gathered and compared with prior data to determine the rate at which changes are taking place within formations 48, 50 and 52. This 4D information may be used in the planning of additional drilling operations or in scheduling a workover program for a field.

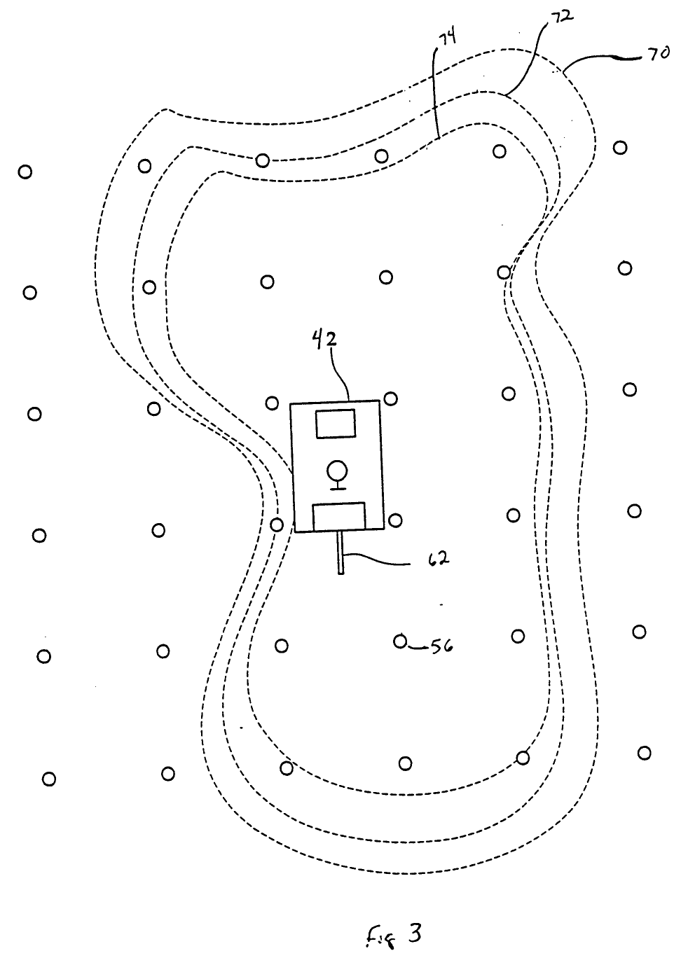

Now turning to FIG. 3, a plan view of platform 42 and an array of seismic signal receivers 56 is depicted. Seismic signal source 24 of FIG. 2 is suspended from support structure 62 of platform 42. A plurality of seismic signal receivers 56 are oriented in a square array beneath platform 42 with platform 42 located at the center of the array. This particular orientation of seismic signal receivers 56 is presented by way of example as it should be apparent to those skilled in the art that seismic signal receivers 56 may be placed in any number of positions and orientations including downhole locations.

FIG. 3 also depicts the depletion of oil from formation 50 of FIG. 2. The dotted line designated 70 represents the initial reserves of oil obtained, for example, using seismic signal source 24 in a static deployed from platform 42 prior to production of fluids from formation 50. After a predetermined production period from formation 50, a subsequent static deployment of seismic signal source 24 may occur. The results of the subsequent deployment are depicted by the dotted line designated 72 which represents the real time oil reserves in formation 50. Similarly, after another period of production from formation 50, a subsequent static deployment of seismic signal source 24 may yield oil reserves which are represented by the dotted line designated 74. Thus, the use of the seismic signal source of the present invention for static deployments may provide substantial valuable information that may be used throughout the life of formation 50.

Referring next to FIGS. 4-7, therein are depicted more detailed views of a seismic signal source, i.e., a seismic signaling apparatus, of the present invention that is generally designated 100. Seismic signal source 100 includes a support frame 102 mounted on a skid 104. In the illustrated embodiment, seismic signal source 100 is configured to be towed behind a marine vessel, such as vessel 12 of FIG. 1. Specifically, a towing cable 106 is attached to support frame 102. A plurality of flotation devices 108 are attached to support frame 102 via lines 110, the length of which determines the depth at which seismic signal source 100 will be operated.

Seismic signal source 100 includes a location determining device such as a global positioning system receiver 112 that receives transmissions from, for example, satellites in a global positioning system. The satellite positions are used by global positioning system receiver 112 as precise reference points to determine the location of seismic signal source 100. When receiving the signals from at least four satellites, the position of seismic signal source 100 can be determined based upon latitude, longitude, altitude and time. By identifying the position of seismic signal source 100 at two different times, the speed and heading of seismic signal source 100 can be determined with conventional algorithms. This precise position and speed information can be used in determining the exaction locations that seismic signal source 100 is operated during a marine survey whether seismic signal source 100 is statically deployed or towed.

An air-gun array 114 is suspended from support frame 102 by gun hangers 116 that may consist of a wire rope having eyelets at either end that are coupled to shackles (not pictured). Preferably, and as illustrated, array 114 consists of eight identical air-guns suspended below support frame 102 such that the air-guns form three distinct horizontal planes. Specifically air-guns 118 form the uppermost plane, air-guns 120 form the middle plane and air-guns 122 form the lowermost plane. Air-guns 118 in the uppermost plane and air-guns 122 in the lowermost planes form pairs of adjacent air-guns. In addition, air-gun array 114 has two distinct vertical planes wherein front mounted air-guns 120 form a pair of adjacent air-guns, center mounted air-guns 118, 122 form pairs of adjacent air-guns and rear mounted air-guns 120 form a pair of adjacent air-guns. This array configuration is symmetric about longitudinal axis X-X and has a 2×4×2 configuration when viewed top to bottom, bottom to top, front to back or back to front. This array configuration of tightly packed air-guns provides a heavy centered, tapered, point seismic source.

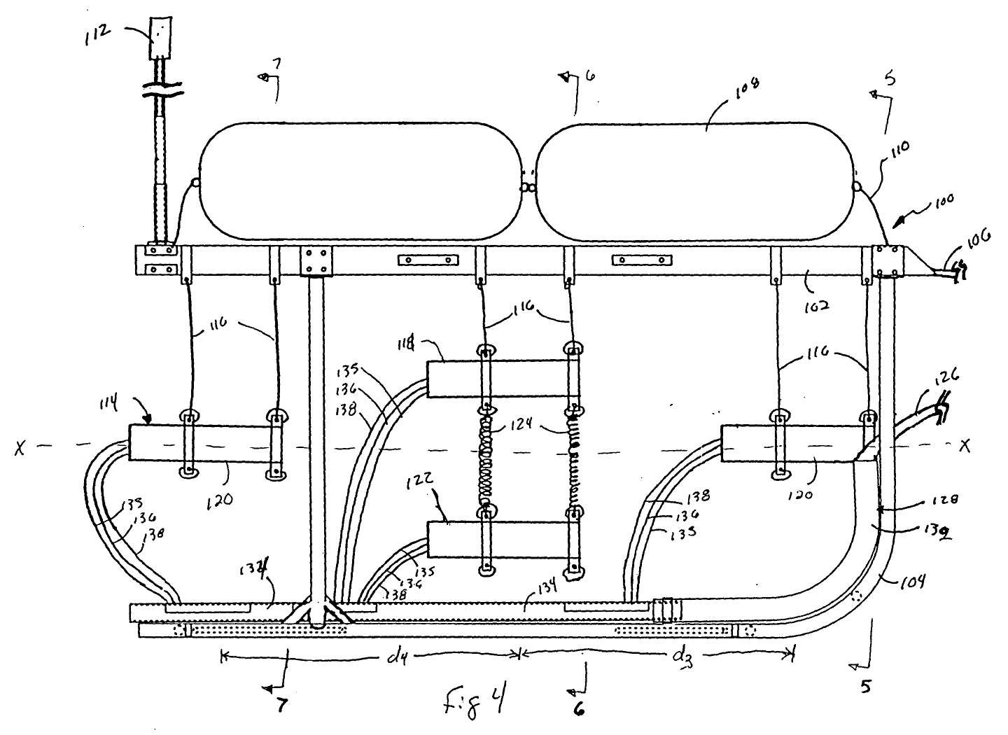

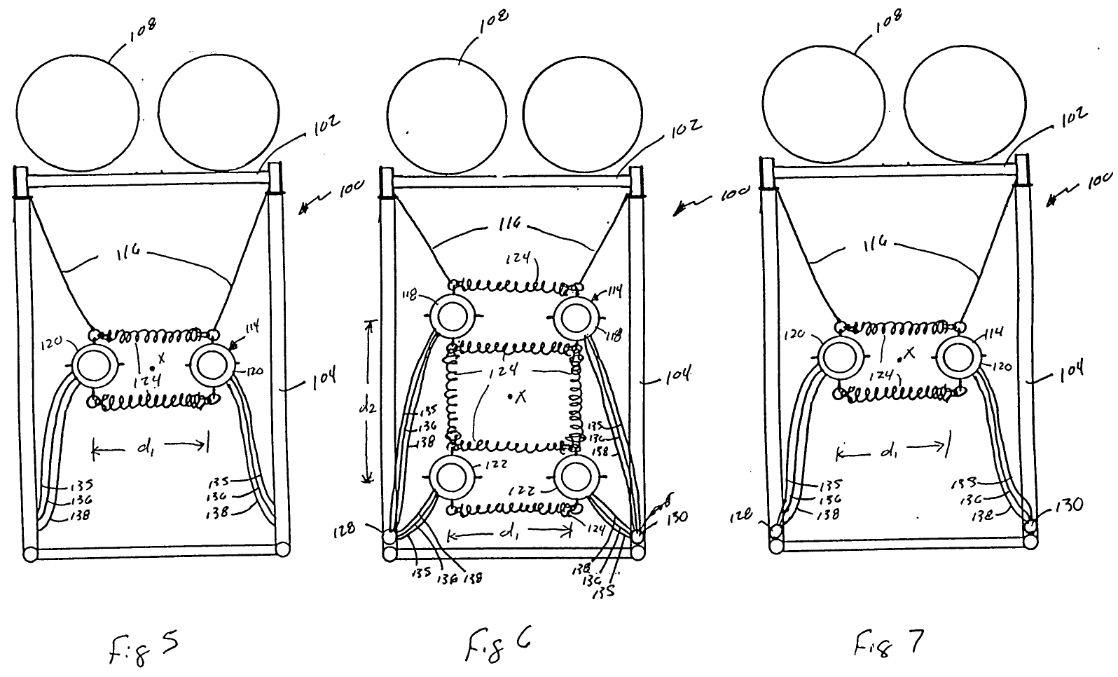

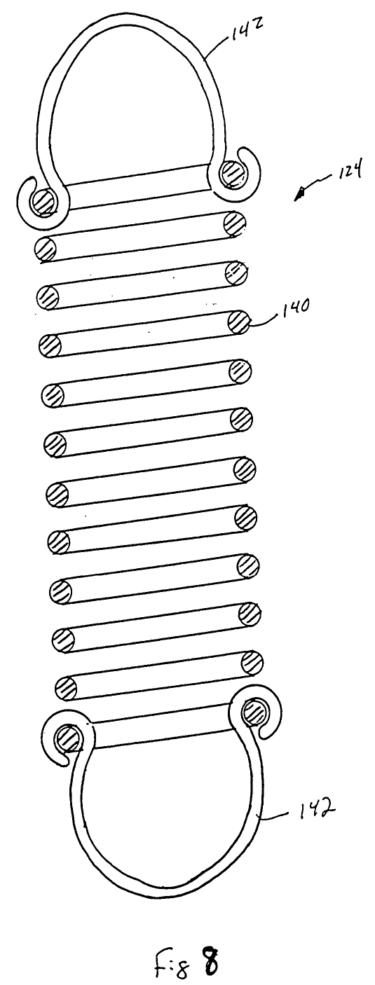

As best seen in FIGS. 4 and 5, one pair of air-guns 120 is operably mounted toward the front of support frame 102 and secured so that they are the same distance below support frame 102. As best seen in FIGS. 4 and 7, another pair of air-guns 120 is mounted toward the rear of support frame 102 and secured so that they are the same distance below support frame 102 and in positions substantially identical to that of the front pair of air-guns 120. As best seen in FIGS. 4 and 6, two pairs of air-guns 118, 122 are mounted in the middle of support frame 102 and secured so that the air-guns of each pair are the same distance below support frame 102. The two air-guns on each side are in vertical alignment with one another.

More specifically, the air-guns are symmetrical about the longitudinal axis X-X and equidistant therefrom. The horizontal distance between each pair of air-guns 118, 120, 122 is shown in FIGS. 5, 6 and 7 as d₁ with the equidistant spacing of each air-gun from the longitudinal axis X-X being d₁/2. The vertical distance between the center pairs of air-guns 118, 122 is shown as distance d₂ in FIG. 6 with the air-gun spacing above and below the horizontal plane defined by the longitudinal axis X-X being d₂/2. The longitudinal spacing between the centers of the front pair of air-guns 120 and the middle pairs of air-gun 118, 122 is shown as distance d₃. The longitudinal spacing between the centers of the rear pair of air-guns 120 and the middle pairs of air-gun 118, 122 is shown as distance d₄. Preferably the distances d₃ and d₄ are equal so that air-guns 120 constituting the front and rear pairs are spaced from the middle pairs of air-guns 118, 122 at equal distances. As stated above, this configuration provides a 2×4×2 geometric arrangement having the characteristics of a tapered, heavy centered, point source.

The symmetric source configuration utilized by seismic signal source 100 eliminates survey to survey differences due to directionality, i.e., forward and backward propagating wavelets are indistinguishable and port and starboard propagating wavelets are indistinguishable. In addition, the compact form of seismic signal source 100 permits point source performance which eliminate anisotropy artifacts from the received data. Further, the symmetry of the array generates an output wavelet with a broad frequency spectrum that is identical for any pair of reciprocal azimuths, thus removing the immediate differences typically introduced to a data set by a conventional towed linear array. The symmetry of the array also generates an output wavelet that is the same for port or starboard evaluation at the same azimuth to the boat direction in a towed situation.

As stated above, all the air-guns of seismic signal source 100 may be simultaneously fired or, due to the multi-plane arrangement of the air-guns, sequentially fired yielding a system with additional signature improvement over conventional towed linear source arrays. Firing the planes in sequence, the upper plane followed by the middle plane then the lower plane synchronized with the down-going wavefront, enables constructive interference of the down-going wavefront while the delay between the up-going wavefronts reduces the severity of the ghost notch, enabling a flatter, broader output spectrum. Firing times for the different levels can be adjusted to maximize the energy in the desired frequency range for the output far field wavelet. The proximity of the two pairs of air-guns 118, 122 in the middle cluster further improves the array output through bubble interaction that reduces unwanted bubble noise.

Seismic signal source 100 is a scalable system wherein the total gun volume may be adjusted by the substitution of guns with different volumes. For example, if eight air-guns having a 10 cubic inch volume are used, the total air volume is 80 cubic inches. Likewise total gun volumes of 160, 320, 560, 880 and 1200 cubic inches may be achieved. In addition, for applications requiring even higher signal energy levels, larger volumes are achievable by towing or deploying multiple seismic signal sources 100. For example, two 1200 cubic inches arrays may be towed or deployed in tandem to produce a volume of 2400 cubic inches. Likewise three, four or more seismic signal sources 100 could alternatively be towed or deployed.

Seismic signal source 100 of the present invention utilizes a substantially rigid gun support system to increase the shot to shot signature stability and repeatability. Specifically, between each adjacent air-gun is a shock absorbing member depicted as spring-loaded shock mounts 124. More specifically, as illustrated in FIG. 4, spring-loaded shock mounts 124 are positioned vertically between air-guns 118 and 122. As illustrated in FIG. 5, spring-loaded shock mounts 124 are positioned horizontally between air-guns 120. As illustrated in FIG. 6, spring-loaded shock mounts 124 are positioned vertically and horizontally between air-guns 118 and 122. As illustrated in FIG. 7, spring-loaded shock mounts 124 are positioned horizontally between air-guns 120.

Use of spring-loaded shock mounts 124 between each air-gun absorbs recoil and fixes the air-gun positions within support frame 102 and skid 104, thereby maintaining proper air-gun positions enabling consistent and repeatable bubble interaction and hence consistent and repeatable array output. This prevents damage through collisions of the air-guns and other equipment to create consistent, repeatable bubble interaction for maximum signature stability. In addition, use of spring-loaded shock mounts 124 between each air-gun not only reduces maintenance costs, but also reduces the quantity of spare air-guns required on board. The substantially rigid support system also removes any limiting maximum and minimum tow speed to maintain array characteristics, thereby allowing seismic signal source 100 to be used as a static array for applications such as vertical seismic profiling, wherein seismic signal source 100 is suspended from a fixed point.

The operation of the air-guns of seismic signal source 100 is controlled via a control cable umbilical 126 that includes high-pressure air supply conduits, timing lines and firing lines. The portion of control cable umbilical 126 that is required to operate the starboard side air-guns is routed into a protective housing 128 on the starboard side of skid 104, as best seen in FIG. 4. Likewise, the portion of control cable umbilical 126 that is required to operate the port side air-guns is routed into a protective housing 130 on the port side of skid 104, which is visible in FIGS. 6 and 7. Protective housing 128 included a reinforced rubber section 132 and a tubular steel section 134.

Each protective housing 128, 130 provides protection to the control conduits that make up control cable umbilical 126. Use of protective housings 128, 130 is desirable during operation of seismic signal source 100 as significant forces are generated upon firing seismic signal source 100 which tend to damage these control conduits. Importantly, control cable umbilical 126 is routed below the air-guns as opposed to above the air-gun as it has been determined that the life of control cable umbilical 126 is enhanced in this configurations due to the difference in the forces generated in the downward direction versus the forces generated in the upward direction when the air-guns are fired.

Each air-gun receives three control conduits from control cable umbilical 126. Specifically, each air-gun has a high-pressure air supply conduit 135, a timing conduit 136 and a firing conduit 138. Each high-pressure air supply conduit 135 provides the air pressure to charge each of the air-guns. Each timing conduit 136 and each firing conduit 138 provide the required firing and sequencing information to the respective air-guns. Control of the air-guns is well known the those of skill in the art.

In operation, the seismic signaling apparatus is deployed in the water and the firing of the air-guns is controlled by the control cable umbilical. Upon firing, the air-guns provide a tapered, heavy centered, point source seismic signal. The firing also produces recoil of the air-guns. The recoil may take the form of each air-gun moving horizontally, vertically or combinations thereof relative to the support frame and the other air-guns. The spring-loaded shock mounts 124 positioned between the air-guns absorb this recoil energy, thereby maximizing the stability of the seismic signaling apparatus by maintaining the positions of the air-guns relative to each other, the skid and the support frame. Additionally, the spring-loaded shock mounts 124 guarantee accuracy and precision of subsequent firings of the air-guns by minimizing the effect of the recoil such that air-guns may fire from the same position repeatedly.

Referring next to FIG. 8, therein is depicted a spring-loaded shock mount 124 that is positionable between two adjacent air-guns. In the illustrated embodiment, each spring-loaded shock mount 124 is attached between two adjacent air-guns to absorb the force of the air-guns after being shot. Each spring-loaded shock mount 124 includes a spring 140 and a pair of latches 142. Springs 140 are preferably constructed from a stainless steel, such as a 309 stainless steel, to prevent rusting or corrosion. Springs 140 preferably have an outside diameter of between two and five inches and most preferably about three inches. Springs 140 preferably have a cross sectional thickness of between one-quarter of an inch and one inch and most preferably about one-half of an inch. Springs 140 preferably have a load deflection that is equivalent to between 150 and 400 pounds of pressure for a deflection of one inch and most preferably about 200 pounds of pressure for a deflection of one inch.

Latches 142 are preferably constructed from a corrosion-resistant alloy due to the severity of the service required by latches 142. Preferably, latches 42 are constructed from a nickel-chromium alloy. More preferably, latches 42 are constructed from an Iconel® alloy. Latches 142 are attached near the ends of each spring 140 around one or more coils of spring 140. In operation, latches 142 are coupled to shackles (not pictured) that are coupled to the air-guns.

Through use of spring-loaded shock mounts 124, the operation of seismic signal source 100 is improved. Specifically, horizontal and vertical movement of the air-guns is minimized and the stability of the air-gun array is increased which allows for better data to be collected due to enhanced shot to shot repeatability. Also, use of spring-loaded shock mounts 124 significantly enhances the life of the air-guns. Specifically, the forces, including recoil, produced by the air-guns during operation is extremely high which urges the air-guns to shift in position, however, spring-loaded shock mounts 124 provide a resilient and elastic semi-rigid medium that absorbs these forces and keeps the air-guns in a substantially fixed position creating a substantially rigid array configuration. Therefore, the spring-loaded shock mounts of the present invention provide improved stability as compared to existing connection members which comprise non-resilient and non-elastic couplings that do not provide for the absorption of force.

As should be apparent to those skilled in the art, the seismic signal source of the present invention provides for improved seismic surveys in a variety of seismic application. For example, the seismic signal source of the present invention is suitable for time lapse seismic or 4D imaging which is used from exploration through production to depletion, for vertical seismic profiling wherein downhole sensor are inserted into producing wellbores to aid in detailed reservoir characterization, for high resolution 2D and 3D imaging to verify the near surface stability of the water bottom for expensive offshore construction and to allow the planning of wells to avoid dangerous shallow water flows and near surface gas pockets as well as for shallow water seismic including remote storage and multimode recording electronics that allow for cost effective application of 2D and 3D in shallow water transition zone areas that have previously been considered as no go areas for traditional seismic methods.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A seismic signaling apparatus, comprising:
a support frame;
an air-gun array operably mounted to the support frame such that a tapered, heavy centered, point source seismic signal is generated upon firing the air-gun array; and
at least one shock absorbing member attached to a pair of adjacent air-guns in the air-gun array that is operable to absorb a force generated upon firing the air-gun array.

2. The seismic signaling apparatus as recited in claim 1 wherein the air-gun array further comprises air-guns in two parallel vertical planes and wherein the at least one shock absorbing member further comprises shock absorbing members attached to respective pairs of adjacent air-guns in the two parallel vertical planes.

3. The seismic signaling apparatus as recited in claim 1 wherein the air-gun array further comprises air-guns in two parallel horizontal planes and wherein the at least one shock absorbing member further comprises shock absorbing members attached to respective pairs of adjacent air-guns in the two parallel horizontal planes.

4. The seismic signaling apparatus as recited in claim 1 wherein the air-gun array further comprises air-guns in two parallel vertical planes and air-guns in two parallel horizontal planes and wherein the at least one shock absorbing member further comprises shock absorbing members attached to respective pairs of adjacent air-guns in the two parallel vertical planes and respective pairs of adjacent air-guns in the two parallel horizontal planes.

5. The seismic signaling apparatus as recited in claim 1 wherein the at least one shock absorbing member further comprises a spring-loaded shock mount.

6. The seismic signaling apparatus as recited in claim 5 wherein the spring-loaded shock mount further comprises a spring coupled between a pair of latches.

7. The seismic signaling apparatus as recited in claim 5 wherein the spring-loaded shock mount further comprises a spring formed from a stainless steel.

8. The seismic signaling apparatus as recited in claim 5 wherein the spring-loaded shock mount further comprises a latch formed from a corrosion-resistant alloy.

9. The seismic signaling apparatus as recited in claim 1 wherein the support frame is configured for towing in the water behind a marine vessel.

10. The seismic signaling apparatus as recited in claim 1 wherein the support frame is configured for static deployment in the water.

11. A seismic signaling apparatus, comprising:
a support frame;
an air-gun array operably mounted to the support frame such that a tapered, heavy centered, point source seismic signal is generated upon firing the air-gun array; and
a global positioning system receiver coupled to the support frame, the global positioning system receiver operable to communicate with a global positioning system in order to determine the location of the seismic signaling apparatus.

12. The seismic signaling apparatus as recited in claim 11 wherein the air-gun array has a 2×4×2 configuration.

13. The seismic signaling apparatus as recited in claim 11 wherein the support frame is configured for towing in the water behind a marine vessel.

14. The seismic signaling apparatus as recited in claim 11 wherein the support frame is configured for static deployment in the water.

15. A seismic signaling apparatus, comprising:
a support frame;
an air-gun array operably mounted to the support frame such that a tapered, heavy centered, point source seismic signal is generated upon firing the air-gun array, the air-gun array having air-guns in two parallel vertical planes and air-guns in two parallel horizontal planes;
substantially horizontal shock absorbing members attached to respective pairs of adjacent air-guns in the two parallel vertical planes that are operable to minimize horizontal air-gun movement generated upon firing the air-gun array; and
substantially vertical shock absorbing members attached to respective pairs of adjacent air-guns in the two parallel horizontal planes that are operable to minimize vertical air-gun movement generated upon firing the air-gun array.

16. The seismic signaling apparatus as recited in claim 15 wherein the shock absorbing members further comprise spring-loaded shock mounts.

17. The seismic signaling apparatus as recited in claim 16 wherein the spring-loaded shock mounts further comprise springs coupled between a pair of latches.

18. The seismic signaling apparatus as recited in claim 16 wherein the spring-loaded shock mounts further comprise spring formed from a stainless steel.

19. The seismic signaling apparatus as recited in claim 16 wherein the spring-loaded shock mounts further comprise latches formed from a corrosion-resistant alloy.

20. The seismic signaling apparatus as recited in claim 15 wherein the support frame is configured for towing in the water behind a marine vessel.

21. The seismic signaling apparatus as recited in claim 15 wherein the support frame is configured for static deployment in the water.

22. The seismic signaling apparatus as recited in claim 15 further comprising a global positioning system receiver coupled to the support frame that is operable to communicate with a global positioning system in order to determine the location of the seismic signaling apparatus.

23. A method for enhancing the signal repeatability of a seismic signaling apparatus comprising the steps of:
deploying the seismic signaling apparatus in the water, the seismic signaling apparatus including an air-gun array operably mounted to the support frame;
firing the air-guns in the air-gun array to producing a tapered, heavy centered, point source seismic signal; and
absorbing a force between at least two of the air-guns in the air-gun array generated upon firing the air-gun array with a shock absorbing member attached to the at least two of the air-guns.

24. The method as recited in claim 23 wherein the step of absorbing a force between at least two of the air-guns in the air-gun array further comprises minimizing vertical air-gun movement generated upon firing the air-gun array.

25. The method as recited in claim 23 wherein the step of absorbing a force between at least two of the air-guns in the air-gun array further comprises minimizing horizontal air-gun movement generated upon firing the air-gun array.

26. The method as recited in claim 23 wherein the step of absorbing a force between at least two of the air-guns in the air-gun array further comprises minimizing vertical air-gun movement generated upon firing the air-gun array and minimizing horizontal air-gun movement generated upon firing the air-gun array.

27. The method as recited in claim 23 wherein the step of absorbing a force between at least two of the air-guns in the air-gun array further comprises maintaining the air-guns in the air-gun array in a substantially fixed positioned during the firing step.

28. The method as recited in claim 23 wherein the step of absorbing a force between at least two of the air-guns in the air-gun array further comprises stabilizing the air-guns in the air-gun array during the firing step.

29. The method as recited in claim 23 wherein the step of absorbing a force between at least two of the air-guns in the air-gun array further comprises absorbing a force between pairs of adjacent air-guns in two parallel vertical planes of air-guns in the air-gun array.

30. The method as recited in claim 23 wherein the step of absorbing a force between at least two of the air-guns in the air-gun array further comprises absorbing a force between pairs of adjacent air-guns in two parallel horizontal planes of air-guns in the air-gun array.

31. The method as recited in claim 23 wherein the step of deploying the seismic signaling apparatus in the water further comprises towing the seismic signaling apparatus behind a marine vessel.

32. The method as recited in claim 23 wherein the step of deploying the seismic signaling apparatus in the water further comprises statically deploying the seismic signaling apparatus in the water.

33. The method as recited in claim 23 further comprising the step of determining the location of the seismic signaling apparatus with a global positioning receiver coupled to the seismic signaling apparatus.
